(19) United States
(12) Patent Application Publication
(10) Pub. No.: US 2010/0099430 A1
(43) Pub. Date: Apr. 22, 2010

(54) SYSTEM AND METHOD FOR CONTROLLING PUSH-TO-TALK OVER CELLULAR (PoC) MEDIA BURST TIME

(75) Inventor: Kyoungtak Kim, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/537,641

(22) Filed: Aug. 7, 2009

(30) Foreign Application Priority Data
Oct. 21, 2008 (KR) 10-2008-0103081

(51) Int. Cl. H04W 72/00

(52) U.S. Cl. 455/452.1

(57) ABSTRACT

A method for controlling push-to-talk over cellular (PoC) media burst time includes receiving a burst request time from a PoC client, identifying a burst allocation time corresponding to the PoC client in a database, selecting a burst time for the PoC client based on the burst allocation time and the burst request time, and allowing a data burst from the PoC client at the burst time. A system to control PoC media burst time includes an information receiver to receive the burst request time, an information identifier to identify the burst allocation time for a database, a time selector to select the burst time, and a burst allowing unit to allow the data burst from the PoC client at the selected burst time.

### CROSS-REFERENCE TO RELATED APPLICATION

This application claims priority from and the benefit of Korean Patent Application No. 10-2008-0103081, filed on Oct. 21, 2008, which is hereby incorporated by reference for all purposes as if fully set forth herein.

### BACKGROUND OF THE INVENTION

1. Field of the Invention

The present invention relates to a method for controlling a push-to-talk over cellular (PoC) media burst time based on a burst request time received from the PoC client and a burst allocation time stored in a database, and a system to perform the method.

2. Discussion of the Background

PoC stands for Push-to-talk over Cellular, and is a representative application of an IP multimedia subsystem (IMS)-based application. PoC has been developed as an application for transferring multimedia content between users, more than is currently available using a simple voice-based push to talk (PTT) capability that is available under the Open Mobile Alliance (OMA) PoC 1.0 standard.

A PoC service uses a session initiation protocol (SIP) to generate a session between users. However, once the session is generated, media burst between users is controlled by a media burst control protocol. A media burst time of participants who participate in a PoC session is either evenly allocated among the participants or only allocated to a predetermined participant.

The PoC may client wish to extend the media burst time, but each of a PoC moderator/PoC server restricts a media burst time for each PoC client.

FIG. 1 is a flowchart illustrating a method for controlling a PoC media burst time according to the conventional art.

When the PoC client requests a media transmission authority from the PoC server, the PoC client sends an MB_Request in operation S110. Then, the PoC server checks a deny condition with respect to the media burst authority of the PoC client in operation S120, and if the deny condition is satisfied, the PoC server denies the media burst authority and sends a MB_Deny to the PoC client in operation 130. Then, the PoC client may request the media burst authority again.

However, if the deny condition is not satisfied, the PoC server grants the media burst authority and sends a MB_Granted in operation S140. The PoC server also operates a T2 timer to count a media burst time in operation S150, and the PoC client may perform the media burst to all PoC clients participating in a PoC session in operation S 160. When the media burst time expires, that is, when T2 timer expires (H), the PoC server limits the media burst of the PoC client and sends a MB_Revoke in operation 170.

Conventionally, when the PoC client obtains a media burst authority, media burst is allowed only during a media burst time determined by the PoC server. However, there is a need for allocating a media burst time according to a position of the participant in the session or a membership, and for changing the media burst time allocated during the media burst.

### SUMMARY OF THE INVENTION

Exemplary embodiments of the present invention provide a method for controlling push-to-talk over cellular (PoC) media burst time where a burst time is selected with respect to a PoC client based on a burst request time received from the PoC client and a burst allocation time stored in a database. According to the method, data burst may be allowed from the PoC client at the selected burst time, thereby more dynamically allocating a burst time of the PoC client participating in a PoC session.

Exemplary embodiments of the present invention also provide a system to control push-to-talk over cellular (PoC) media burst time where a burst time is selected with respect to a PoC client based on a burst request time received from the PoC client and a burst allocation time stored in a database. A data burst may be allowed from the PoC client at the selected burst time, thereby more dynamically allocating a burst time of the PoC client participating in a PoC session.

Exemplary embodiments of the present invention also provide a method for extending push-to-talk over cellular (PoC) media burst time during a selected burst time upon request from the PoC client allocated the selected burst time.

Exemplary embodiments of the present invention also provide a system to extend push-to-talk over cellular (PoC) media burst time during a selected burst time upon request from the PoC client allocated the selected burst time.

Additional features of the invention will be set forth in the description which follows, and in part will be apparent from the description, or may be learned by practice of the invention.

An exemplary embodiment of the present invention discloses a method for controlling PoC media burst time, including receiving a burst request time from a first PoC client, identifying a burst allocation time corresponding to the first PoC client in a database, selecting a selected burst time with respect to the first PoC client based on the identified burst allocation time and the received burst request time, and allowing data burst from the first PoC client corresponding to the selected burst time.

An exemplary embodiment of the present invention also discloses a system to control PoC media burst time, including an information receiver to receive a burst request time from a first PoC client, an information identifier to identify a burst allocation time corresponding to the first PoC client in a database, a time selector to select a selected burst time with respect to the first PoC client based on the identified burst allocation time and the received burst request time, and a burst allowing unit to allow data burst from the first PoC client corresponding to the selected burst time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for controlling PoC media burst time according to the conventional art.

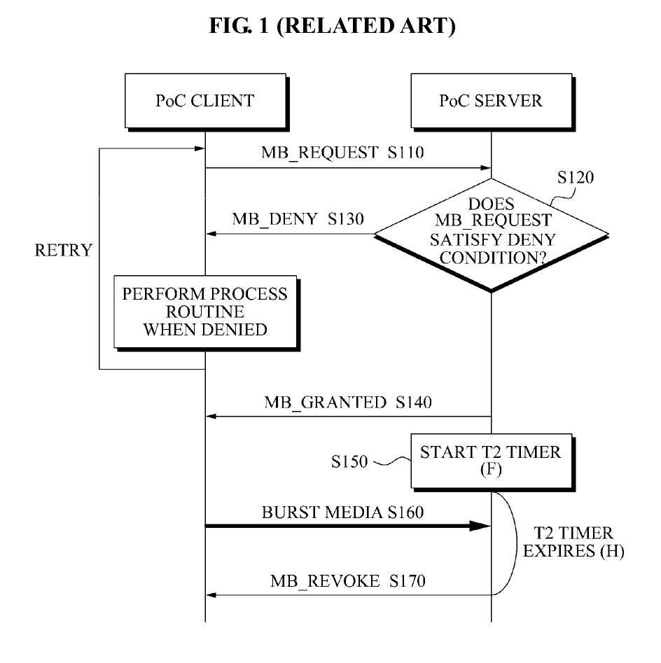

FIG. 2 illustrates a configuration of a PoC media burst time controlling system according to an exemplary embodiment of the present invention.

FIG. 3 is a flowchart illustrating a method for controlling PoC media burst time according to an exemplary embodiment of the present invention.

FIG. 4 illustrates a media burst request message according to an exemplary embodiment of the present invention.

FIG. 5 illustrates a media burst request message according to an exemplary embodiment of the present invention.

FIG. 6 illustrates a media burst request extension message according to an exemplary embodiment of the present invention.

FIG. 7 is a flowchart illustrating a method for controlling PoC media burst time according to an exemplary embodiment of the present invention.

FIG. 8 illustrates a media burst authority message according to an exemplary embodiment of the present invention.

FIG. 9 illustrates a media burst report message according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

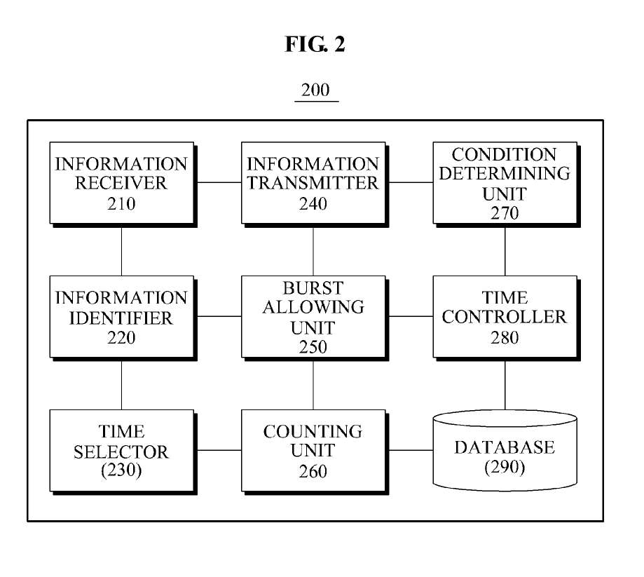

FIG. 2 illustrates a configuration of a PoC media burst time controlling system according to an exemplary embodiment of the present invention.

As illustrated in FIG. 2, a PoC media burst time controlling system 200 may include an information receiver 210, an information identifier 220, a time selector 230, an information transmitter 240, a burst allowing unit 250, a counting unit 260, a condition determining unit 270, a time controller 280, and a database 290.

The information receiver 210 may receive a burst request time from a PoC client. The PoC client may be embedded in a terminal or the like, and accesses a network to provide a PoC service to a PoC service subscriber. The PoC client may set up a PoC session, may participate in an existing session, or may terminate a session.

Also, the burst request time may be a burst time desired by the PoC client, and may be used if a burst time of the PoC client is allocated.

As an example, the information receiver 210 may receive a membership condition of the PoC client together with the burst request time from the PoC client. The membership condition may be used for determining the burst allocation time, and the burst allocation time may be selected according to the membership condition.

The information identifier 220 may identify the burst allocation time corresponding to the PoC client from the database 290.

The database 290 may organize and store burst allocation times according to membership conditions of PoC clients. As an example, the membership conditions may be classified into a gold membership condition, a silver membership condition, and a general membership condition, where the gold membership condition has 5 minutes of burst allocation time, the silver membership condition has 4 minutes of burst allocation time, and the general membership condition has 2 minutes of burst allocation time. The membership condition may be determined for each PoC client based on a coupon, a service charge according to use of the PoC service, and/or whether the PoC client is a leader or a team member in a group, and the like.

Accordingly, the information identifier 220 may identify the burst allocation time corresponding to the membership condition of the PoC client.

The time selector 230 may select a burst time with respect to the PoC client based on the identified burst allocation time and the received burst request time.

As an example, the time selector 230 may allocate the burst request time as the burst time if the burst request time is in a range of the burst allocation time including a time range. In more detail, the burst time for the PoC client may be equal to the burst request time if the burst request time is less than or equal to a sum of the burst allocation time from the database 209 and a time range

For example, if the burst allocation time is 2 minutes and the time range is 1 minute, then the range of the burst allocation time including the time range is 3 minutes. If the burst request time sent from the PoC client is 3 minutes, then it is in the range, and the time selector 230 may select 3 minutes of burst request time as the burst time.

However, if the burst allocation time is 2 minutes and the time range is 30 seconds, then the range of the burst allocation time including the time range is 2 minutes 30 seconds. If the burst request time is 3 minutes, the burst request time is not in this range. Thus, the time selector may select either the 2 minutes of burst allocation time or 2 minutes and 30 seconds, the range, as the burst time. The selection of one of these two options may be preset, or it may depend upon the membership condition of the PoC client.

Also, the time range may be different according to the membership condition. As an example, a gold membership condition may have a 2 minute time range, a silver membership condition may have a 1 minute time range, and a general membership condition may have 30 second time range. Accordingly, the time selector 230 may identify a time range corresponding to the membership condition of the PoC client and may use the identified time range for selecting the burst time.

As an example, if the burst allocation time of the PoC client corresponding to the gold membership condition is 3 minutes, the time range is 2 minutes, and the burst request time from the PoC client is 4 minute, the burst request time is in the range of the burst allocation time including the time range. Thus, the time selector 230 may select the 4 minutes of burst request time as the burst time.

However, if the burst allocation time of the PoC client corresponding to the silver membership condition is 2 minutes, the time range is 1 minute, and the burst request time is 4 minutes, the burst request time is not in the range of the burst allocation time including the time range. Thus, the time selector 230 may select either the 2 minutes of burst allocation time or 3 minutes, the sum of the time range and the burst allocation time, as the burst time.

The information transmitter 240 may transmit the selected burst time to one or more PoC clients. This is to report that a PoC client is able to burst data during the burst time.

As an example, the information transmitter 240 may transmit burst authority information of the burst time selected with respect to a first PoC client to a second PoC client participating in a PoC session related to the first PoC client. This may be to report that the first PoC client is performing a burst transmission during the burst time, and thus, the second PoC client would not be able to perform a burst transmission during the burst time of the first PoC client having the burst authority.

The burst allowing unit 250 may allow a data burst from the PoC client during the allocated burst time. That is, the PoC client may burst data only during the burst time.

The counting unit 260 may count the burst time of the PoC client. This is to allow a burst transmission of the PoC client only during the allocated burst time, and to limit the data burst of the PoC client after the burst time has expired.

If a request for extending the burst time is received from the PoC client during the selected burst time, the condition determining unit 270 may determine whether the request satisfies a burst time extending condition. As an example, the condition determining unit 270 may receive the burst request time and the membership condition from the PoC client before the burst time is expired. In this instance, the burst request time may be identical to or different from the previously transmitted burst request time.

The burst time extending condition may be satisfied if a number of extensions performed with respect to the selected burst time is within an allocated number, or if the original burst request time is within a range of the burst allocation time including a time range.

As an example, if the allocated number is two, extensions to the selected burst time may be performed only twice. Accordingly, if the requested extension number is within the allocated number, the condition determining unit 270 may determine that the request satisfies the burst time extending condition.

As another example, if the burst request time is 2 minutes, the burst allocation time is 1 minute, and the time range is 1 minute, the burst request time is in the range of the burst allocation time including the time range. Thus, the condition determining unit 270 may determine that the request satisfies the burst time extending condition.

In an exemplary embodiment, the burst time extending condition may be satisfied if the burst extension request time plus the selected burst time is within a range of the burst allocation time from the database 209 including a time range. As an example, if the burst request time is 2 minutes, the burst allocation time is 4 minutes, and the time range is 1 minute, the original selected burst time may be 2 minutes. If the PoC client then requests an additional 2 minutes of burst time, the condition determining unit 270 may compare the original selected burst time plus the burst extension request time, or 2 minutes plus 2 minutes, against the range of the burst allocation time from the database 209 including the time range. Thus, if the burst allocation time is 4 minutes, the condition determining unit 270 may allow an additional 2 minutes of burst time extension to the originally selected burst time. The time range used for determining whether a burst time extending condition is satisfied may be the same or different than the time range used for determining the burst time.

The time controlling unit 280 may extend the burst time of the PoC client if the request satisfies the burst time extending condition. The counting unit 260 may start counting with respect to a second burst time from an expiration of the previous burst time.

Accordingly, if the burst time first allocated to the PoC client expires, the burst allowing unit 250 may allow a burst of data from the PoC client during a second burst time allocated to the PoC client.

As described above, if the extension with respect to the burst time of the first PoC client is determined, the information transmitter 240 transmits, to the second PoC client participating in the PoC session related to the first PoC client, burst authority information related to the burst time extended with respect to the first PoC client. That is, if the burst time is changed, the information transmitter 240 transmits the changes to the second PoC client to report the extended burst time of the first PoC client and that the first PoC client retains burst authority through the extended burst time.

However, if the request of the PoC client does not satisfy the burst time extending condition, the burst allowing unit 250 may limit the data burst of the PoC client after the expiration of the burst time of the PoC client.

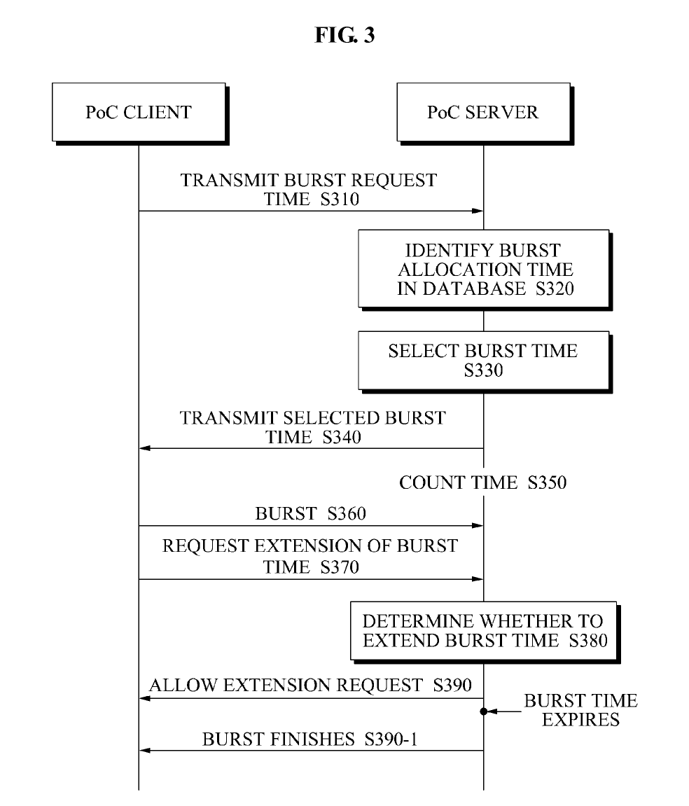

FIG. 3 is a flowchart illustrating a method for controlling PoC media burst time according to an exemplary embodiment of the present invention

The method for extending PoC media burst time may be performed by the PoC media burst time controlling system 200. The method will now be described in more detail with reference to FIG. 2 and FIG. 3. Since a PoC server may be the PoC media burst time controlling system 200, the term “PoC server” will be used instead of the “PoC media burst time controlling system 200.”

In operation S310, the PoC client may transmit a burst request time to the PoC server. To dynamically allocate the burst time according to need as opposed to allocating a same burst time to every PoC client, the PoC client may transmit, to the PoC server, a burst request time with respect to a burst time desired by the PoC client and a membership condition used for determining a burst allocation time. The burst request time and/or the membership condition may be used for determining the burst time.

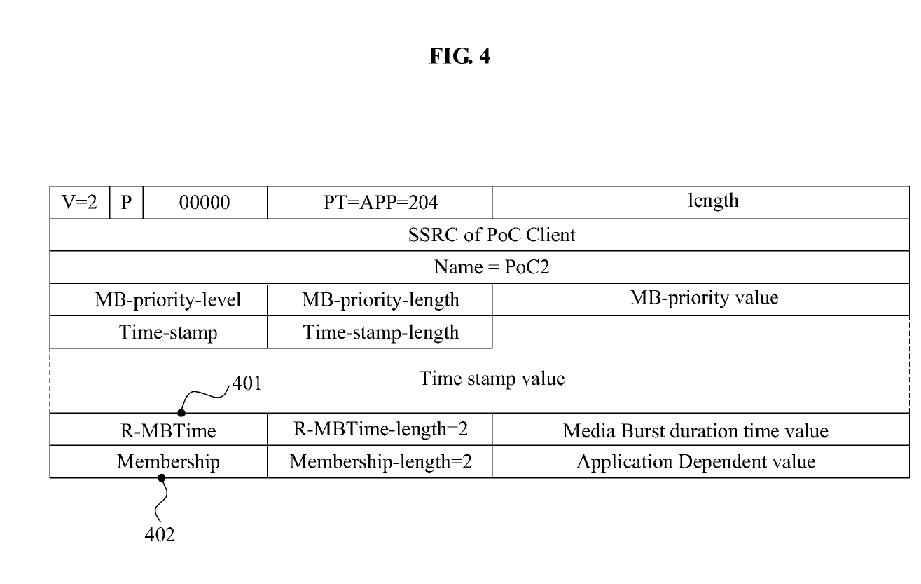

FIG. 4 illustrates a media burst request message according to an exemplary embodiment of the present invention.

Referring to FIG. 4, the media burst request message including an R-MBTime 401 and a Membership 402 and transmits the generated media burst request message to the PoC server. Here, the R-MBTime 401 is the burst request time and the Membership 402 is the membership condition.

The PoC server then determines whether to allow the burst request time based on a user's authority information included in a PoC service subscriber information. However, if the user's authority information is not included in the PoC service subscriber information or if the PoC server determines whether to allow the burst request time preferentially based on the subscriber information, the PoC server may determine whether to allow the burst request time based on the Membership 402. Here, determining whether to allow the burst request time may include at least determining whether to select the burst request time as the burst time.

The PoC server provides the PoC service to the PoC client, and the PoC server may be understood as a moderator.

In operation S320, the PoC server identifies a burst allocation time corresponding to the PoC client from the database 290. The database 290 may store the burst allocation time corresponding to a membership condition of the PoC client. The database 290 may also store the time range, which may also correspond to a membership condition of the PoC client. The burst allocation time and/or time range may be partially or entirely different depending on a membership condition of the PoC client. The membership condition may be differently set for each PoC client according to a coupon, a service charge according to PoC service use, and a member level in a group, and the like.

In operation S330, the PoC server may select the burst time with respect to the PoC client based on the identified burst allocation time and the transmitted burst request time.

As an example, if the burst request time does not exceed a sum of a time range and the burst allocation time, the PoC server may select the burst request time as the burst time.

In operation S340, the PoC server transmits the selected burst time to the PoC client. At or about the same time, to limit a burst time of the PoC client after the burst time expires, the PoC server begins to count the burst time of the PoC client in operation S350.

In operation S360, the PoC client may burst data to another PoC client participating in a PoC session related to the PoC client, through the PoC server.

However, if the burst time is insufficient, the PoC client may request the PoC server to extend the burst time in operation S370, before the burst time expires. With the extension request, the PoC client may transmit the membership condition and the burst request time to the PoC server.

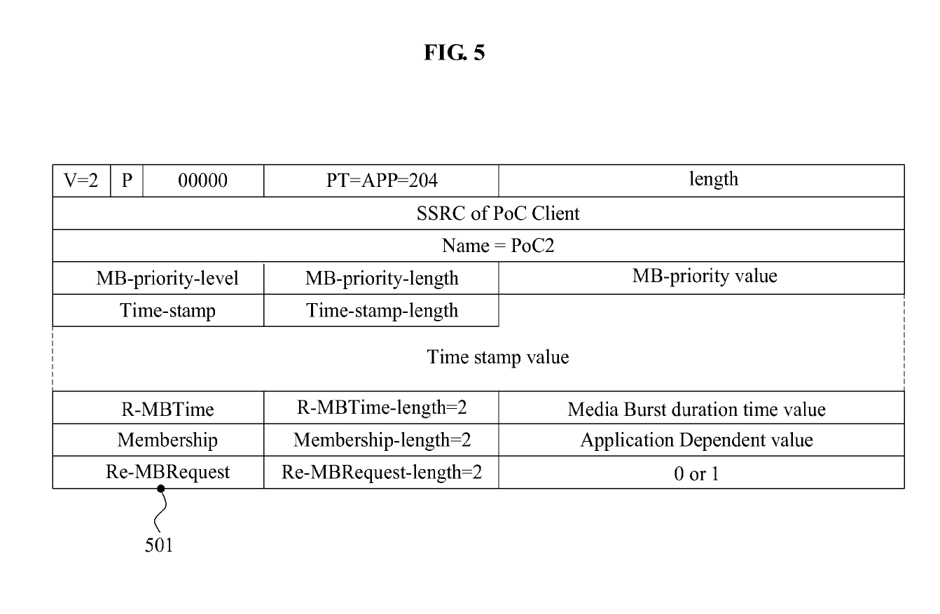

FIG. 5 illustrates a media burst request message according to an exemplary embodiment of the present invention.

The PoC client generates a media burst request message including an option field of a Re-MBRequest 501, and transmits the generated media burst request message to the PoC server. The Re-MBRequest 501 is used for distinguishing an MB-request for requesting an extension of burst time from a common MB-Request, requesting an initial burst time. The PoC server may verify that the media burst request message includes the Re-MBRequest 501. Also, R-MBTime information indicates time information from a time when a request for extending the burst time is received to a time when the burst time expires.

In operation S380, the PoC server determines whether the extension request satisfies a burst time extending condition, and determines whether to extend the burst time of the PoC client.

The burst time extending condition may be satisfied if a number of extensions performed with respect to the allocated burst time is within an allocated number, or if the received burst extension request time is in a range of the time range including the identified burst allocation time. As explained above, in an exemplary embodiment, the burst time extending condition may be satisfied if the received burst extension request time plus the originally selected burst time is within a range of the burst allocation time from the database 209 including the time range. The time range used for determining whether a burst time extending condition is satisfied may be the same or different than the time range used for determining the burst time in operation S330. Also, in an exemplary embodiment, even if there is an allocated number to limit extension requests, there may be an extension request time limit or a total burst time limit that may prevent a single PoC client from continuously requesting and receiving burst extension requests.

If the PoC client request satisfies the burst time extending condition, the PoC server may allow the PoC client extension request in operation S390.

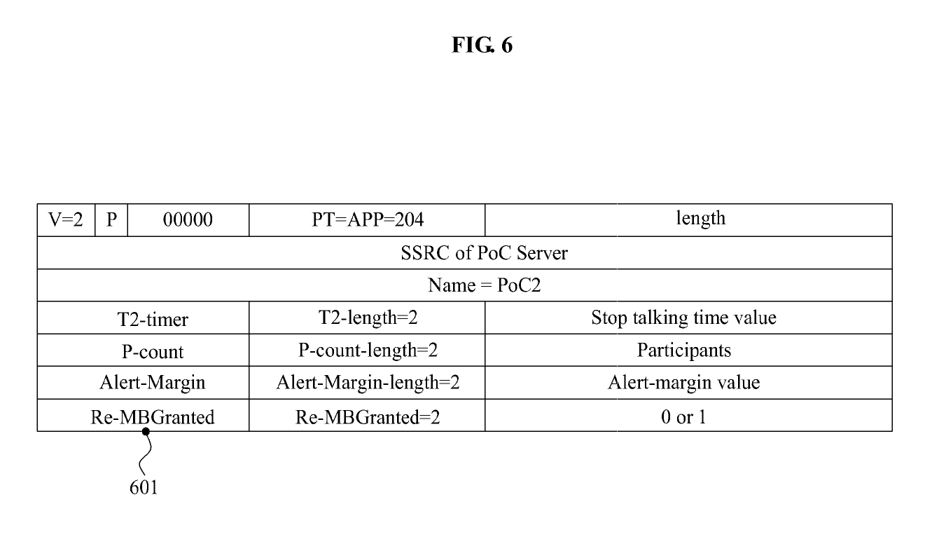

FIG. 6 illustrates a media burst request extension message according to an exemplary embodiment of the present invention.

The PoC server generates a media burst extension message including a Re-MBGranted 601, and transmits the generated media burst extension message to the PoC client. Accordingly, if the media burst extension message is received and the media burst extension message includes the Re-MBGranted 601, the PoC client determines that the request for extending the burst time is allowed. Therefore, the PoC client may continue to perform a data burst to another PoC client participating in the PoC session until the burst extension request time plus the originally selected burst time expires.

Subsequently, in operation S390-1, the PoC server terminates the data burst from the PoC client when the extended burst time expires, which occurs after the originally selected burst time expires.

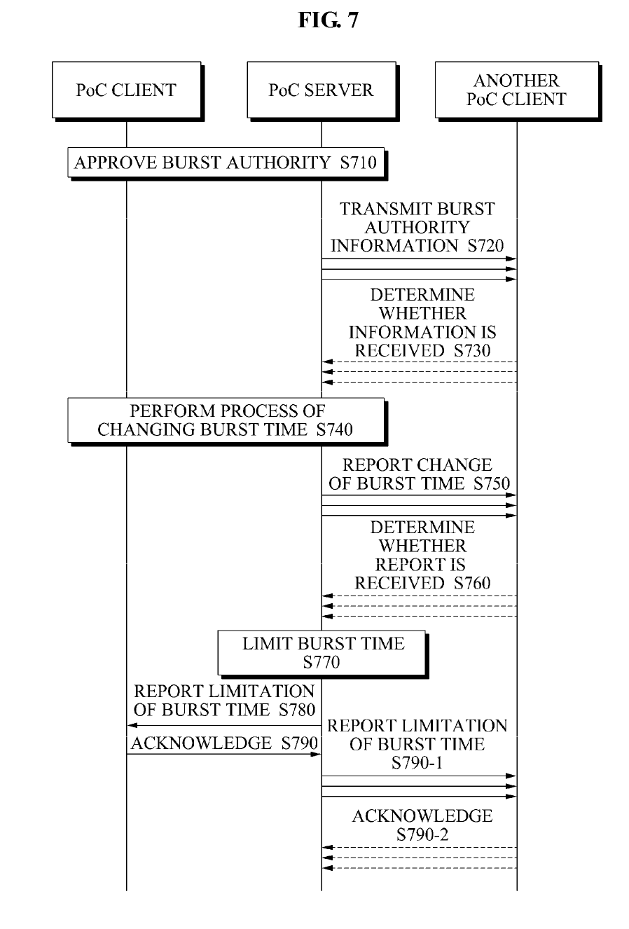

FIG. 7 is a flowchart illustrating a method for controlling PoC media burst time according to an exemplary embodiment of the present invention.

In operation S710 and operation S720, a PoC server approves a burst authority of a PoC client, and transmits burst authority information to another PoC client participating in a PoC session related to the PoC client. The burst authority information includes the burst time of the PoC client and reports that the PoC client has the burst authority.

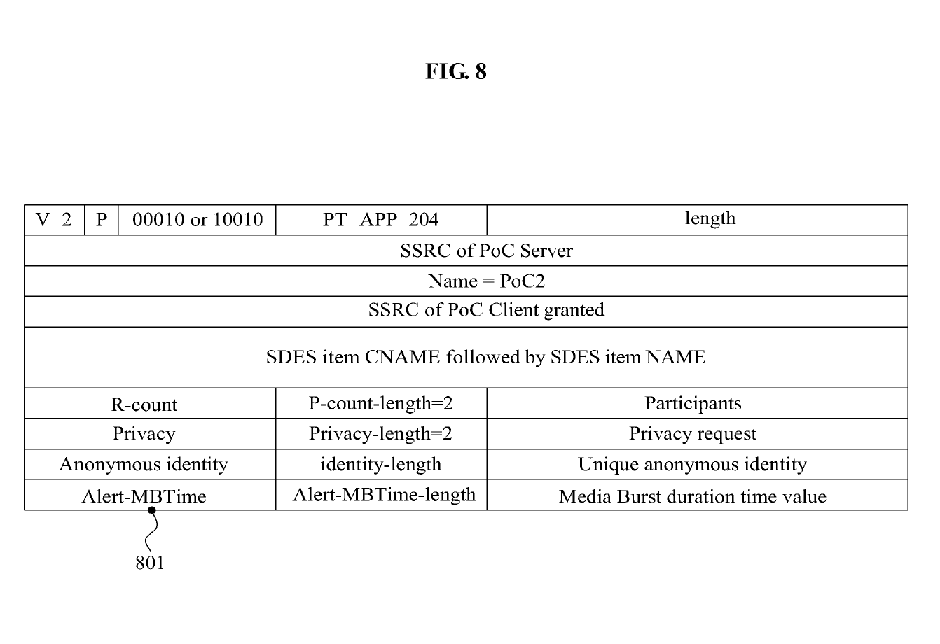

FIG. 8 illustrates a media burst authority message according to an exemplary embodiment of the present invention.

A PoC server may report that a PoC client has a burst authority, may generate a media burst authority message by including information about a PoC client burst time in an Alert-MBTime 801 option field, and may transmit the generated media burst authority message to another PoC client.

In operation S730, the other PoC client verifies that the transmitted burst authority information is received.

In operations S740 and S750, if the burst time of the PoC client is changed, the PoC server performs a process in response to the burst time change, and reports that the PoC client burst time is changed to the other PoC client.

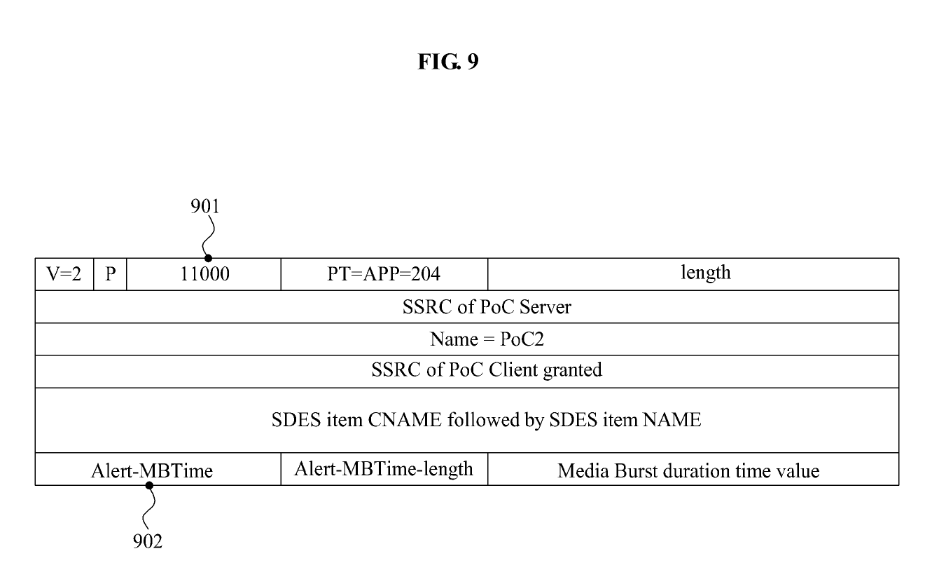

FIG. 9 illustrates a media burst report message according to an exemplary embodiment of the present invention.

If the PoC client burst time is changed, the PoC server may include information about the changed burst time in an Alert-MBTime 902 field, and may give ‘11000’ 901 as a subtype to generate a media burst authority message, and transmit the generated media burst authority message to another PoC client. Here, ‘11000’ 901 shows that the media burst authority message is a new message, and is a value of a reserved area not defined in a OMA PoC standard.

In operation S760, the other PoC client determines that the report about changed burst time is received.

If the PoC client burst time is limited in operation S770, the PoC server reports the burst time limitation to the PoC client and receives a response or an acknowledgement in response to the report in operation S780 and operation S790, respectively. Also, in operation S790-1 and S790-2, the PoC server respectively reports the PoC client burst time limitation to the other PoC, and receives a response or an acknowledgement in response to the report.

The PoC described in the present invention may be implemented in various types of communication services. As an example, in a teleconference, the PoC may be used for assigning more speaking time, namely a burst time, of a participant or for adjusting a speaking time of a participant while the participant is allocated speaking time. Also, the PoC may be used for adjusting speaking times of a leader and team members in a game group during an on-line game. In this instance, the speaking time may be developed as an item in the game, and the participant may purchase a coupon, such as a coupon for extending speaking time, to extend one's speaking time during the game.

The method according to the above-described exemplary embodiments of the present invention may be recorded in computer-readable media including program instructions to implement various operations when executed by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

According to the exemplary embodiments of the present invention, a method for controlling PoC media burst time and a system may select a burst time with respect to a PoC client based on a burst request time received from the PoC client and a burst allocation time stored in a database, the burst allocation time corresponding to a characteristic of the PoC client, and may allow a data burst from the PoC client at the selected burst time. Additionally, the method and system may permit dynamically changing a burst time of the PoC client participating in a PoC session.

According to the exemplary embodiments of the present invention, a method for controlling PoC media burst time and a system may select a burst request time received from a PoC client as a burst time if the burst request time is in a range of a burst allocation time including time range.

According to the exemplary embodiments of the present invention, a method for controlling PoC media burst time and a system may report that a PoC client has burst authority to another client participating in a PoC session if a burst time of the PoC client is changed or if the PoC client is performing a burst, thereby controlling a data burst of another PoC client.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling a push-to-talk over cellular (PoC) media burst time, comprising:
receiving a burst request time from a first PoC client;
identifying a burst allocation time corresponding to the first PoC client in a database;
selecting a selected burst time with respect to the first PoC client based on the identified burst allocation time and the received burst request time; and
allowing a data burst from the first PoC client corresponding to the selected burst time.

2. The method of claim 1, further comprising:
receiving a membership condition from the first PoC client,
wherein identifying the burst allocation time in the database comprises identifying the burst allocation time corresponding to the membership condition in the database.

3. The method of claim 1, wherein selecting the selected burst time comprises selecting the burst request time as the selected burst time if the burst request time is in a range of the burst allocation time including a time range.

4. The method of claim 1, wherein selecting the selected burst time comprises selecting the burst allocation time as the selected burst time if the burst request time exceeds a range of the burst allocation time including a time range.

5. The method of claim 1, further comprising:
transmitting burst authority information of the selected burst time to a second PoC client participating in a PoC session related to the first PoC client.

6. The method of claim 1, further comprising:
receiving a burst time extension request from the first PoC client;
determining whether a burst time extending condition is satisfied; and
extending the selected burst time to an extended burst time if the burst time extending condition is satisfied.

7. The method of claim 6, wherein determining whether the burst time extending condition is satisfied comprises:
determining if a number of extensions performed with respect to the selected burst time is less than or equal to an allocated number.

8. The method of claim 6, wherein determining whether the burst time extending condition is satisfied comprises:
determining whether a burst time extension is in a range of the burst allocation time including a time range.

9. The method of claim 6, further comprising:
transmitting burst authority information of the extended burst time to a second PoC client participating in a PoC session related to the first PoC client.

10. A computer comprising a processor and a storage medium storing a program, the program, when executed, to perform the method of claim 1.

11. A system to control push-to-talk over cellular (PoC) media burst time, comprising:
an information receiver to receive a burst request time from a first PoC client;
an information identifier to identify a burst allocation time corresponding to the first PoC client in a database;
a time selector to select a selected burst time with respect to the first PoC client based on the identified burst allocation time and the received burst request time; and
a burst allowing unit to allow a data burst from the first PoC client corresponding to the selected burst time.

12. The system of claim 11, wherein the information receiver receives a membership condition from the first PoC client, and the information identifier identifies the burst allocation time corresponding to the membership condition in the database.

13. The system of claim 11, wherein the time selector selects the burst request time as the burst time if the burst request time is in a range of the burst allocation time including a time range.

14. The system of claim 11, wherein the time selector selects the burst allocation time as the burst time if the burst request time exceeds a range of the burst allocation time including a time range.

15. The system of claim 11, further comprising:
an information transmitter to transmit burst authority information of the selected burst time to a second PoC client participating in a PoC session related to the first PoC client.

16. The system of claim 11, further comprising:
a condition determining unit to determine whether a burst time extension request from the first PoC client satisfies a burst time extending condition; and
a burst extending unit to extend the burst time to an extended burst time if the burst time extension request satisfies the burst time extending condition.

17. The system of claim 16, wherein the condition determining unit determines if a number of extensions performed with respect to the selected burst time is less than or equal to an allocated number.

18. The system of claim 16, wherein the condition determining unit determines if a burst time extension is within a range of the burst allocation time including a time range.

19. The system of claim 16, further comprising:
an information transmitter to transmit burst authority information of the extended burst time to a second PoC client participating in a PoC session related to the first PoC client.
